(19) United States
(12) Patent Application Publication
(10) Pub. No.: US 2011/0308257 A1
(43) Pub. Date: Dec. 22, 2011

(54) ATTACHMENT STRUCTURE FOR A TURBOJET ENGINE

(75) Inventors: Guy Bernard Vauchel, Harfleur (FR); Andre Baillard, Bretteville du Gran Caux (FR); Francois Conte, Tournefeuille (FR)

(73) Assignee: AIRCELLE, Gonfreville L'Orcher (FR)

(21) Appl. No.: 12/921,239

(22) PCT Filed: Jan. 9, 2009
(86) PCT No.: PCT/FR2009/000022

§ 371 Date: Sep. 7, 2010

(30) Foreign Application Priority Data
Mar. 7, 2008 (FR) 0801264

(51) Int. Cl. F02C 7/20

(52) U.S. Cl. 60/796

(57) ABSTRACT

The present invention relates to an attachment structure (1) for attaching a turbojet engine (2) to a fixed structure of an airplane via an attachment pylon, characterized in that it comprises a one-piece box section intended to extend at least partially on each side of a fan casing (3) of the turbojet engine about a substantially longitudinal axis thereof and comprising, on the one hand, means of attachment to the pylon and, on the other hand, means of attachment of the engine (4) which are positioned on the box section on each side of a substantially longitudinal axis of the turbojet engine and are intended to be connected to part of the turbojet engine in such a way as to react the forces applied thereto.

### TECHNICAL FIELD

This invention relates to an attachment structure for an airplane turbojet engine.

### BRIEF SUMMARY

An airplane is powered by several turbojet engines each housed in a nacelle also housing a system of related actuating devices connected to its operation, such as a thrust inverter device, and providing various functions where the turbojet engine is running or shutdown.

A nacelle has a generally tubular structure comprising an air inlet upstream of the turbojet engine, a middle section intended for surrounding a turbojet fan, a downstream section housing thrust inverter means and intended for surrounding the combustion chamber of the turbojet engine, and is generally completed by an exhaust nozzle the outlet of which is located downstream of the turbojet engine.

Modern nacelles are intended to house a double flow turbojet engine able of generating through the rotating fan blades a hot airflow (also called primary flow) resulting from the combustion chamber of the turbojet engine, and a cold airflow (secondary flow) that flows outside of the turbojet engine through an annular passage, also called stream, formed between a turbojet engine fairing (or an inner structure downstream of the nacelle and surrounding the turbojet engine) and an inner wall of the nacelle. The two airflows are ejected from the turbojet engine from the rear of the nacelle.

Each propulsion system of the airplane is therefore formed by a nacelle and a turbojet engine, and is suspended from a fixed structure of the airplane, such as under a wing or on the fuselage by means of a pylon, or an engine strut, attached to the turbojet engine in its front and rear part by suspension, the system forming a connection interface between the turbojet engine and the fixed structure of the airplane in such a way as to ensure transmission to the airplane structure forces generated by said turbojet.

In such a configuration, the turbojet engine will support the nacelle.

In order to ensure transmission of forces, the pylon has a rigid structure, often of the box section type, that is to say formed by the assembly of upper and lower spars and side panels connected together by means of transverse ribs.

On the other hand, the pylon is equipped with a mounting system inserted between the turbojet engine and the rigid structure of the pylon, this system having as a whole at least two engine attachments, generally at least a front attachment and at least a rear attachment.

Moreover, the mounting system comprises a device such as to react the thrust forces generated by the turbojet engine being classically in the shape of connected side rods, on the one hand, in the rear part of the fan casing, and on the other hand, to a fixed rear attachment on the central casing thereof.

Similarly, the pylon also has a second mounting system inserted between the rigid structure of the pylon and the fixed part of the airplane to which it is intended to be attached.

A classic pylon of the prior art is therefore roughly formed by a rectangular box section, with large dimensions in order to take over all the forces generated by the associated turbojet engine.

Hence, this pylon causes significant turbulences in the secondary flow escaping from the annular fan duct, which leads to greater drag.

Moreover, such architecture is subject to several conjugated outer forces during the mission of the airplane. It concerns, among others, forces resulting from gravity, outer and inner aerodynamic forces, gusts, thermal effects.

These constraints applied to the propulsion system are transmitted to the turbojet engine and cause deformed casings that affect directly the performance of the different stages of the turbojet engine. More specifically, in the case of propulsion system called wasp waist, that is to say having downstream a part relatively long and thin compared to the intermediate and air inlet structures, these constraints resulting in a particularly detrimental deformation called “banana shape”, the downstream part bending significantly.

Such a “banana shape” translates into a deformation of the outer structure of the nacelle formed by the various successive casings while the drive shaft, the fan blades and the inner turbojet engine blades remain straight. It follows an approach of the head blades of the shaft towards the inner periphery of the casings. The overall performance of the turbojet engine is reduced compared to a configuration where the casings are not subjected to any, or very little deformations, as it must therefore take into account of this deformation in the design of the nacelle in such a way as to always leave a spare sufficient clearance between the head blades and the periphery of the casings. This results in a part of the air supply that is not compressed by the blades because it is escaping through this significant clearance.

Document FR 2 885 877 describes an attachment engine strut having a central box section and two side box sections fixed to the central box section and equipped with means of attachment intended to react the forces generated by the turbojet engine.

According to this system, a way to react the forces is then carried out through the side box sections provided for this purpose. The thrust forces passing through the means of attachment of the box sections pass through the skins of these box sections before reaching the central longitudinal box section and then towards the rear of the pylon.

However, a system according to document FR 2 885 877 has the drawback that the side box sections are integral with the engine strut and cannot be separated. It follows that the interface for disassembling the propulsion system is not easily accessible. In particular, the turbojet engine is generally surrounded by a nacelle, the attachment of the system being greatly complicated by the fact that the box sections must be inserted through the nacelle in order to be attached on the turbojet engine.

### BRIEF SUMMARY

The invention proposes another solution allowing to avoid the drawbacks mentioned above while ensuring a way to react the optimal forces, and the purpose of which is, to this end, an attachment structure of a turbojet engine to a fixed structure of an airplane through an engine strut attachment characterised in that it comprises a one-piece box section intended to extend partially on each side of the turbojet engine fan casing around a substantially longitudinal axis thereof and comprising, on the one hand, pylon means of attachment, and on the other hand, means of attachment of the engine arranged on the box section on each side of a substantially longitudinal axis of the turbojet engine and intended to be connected to a part of the turbojet engine in such a way as to react the forces applied thereto.

Thus, by providing a one-piece boxed section structure independent of the pylon, the latter may easily be integrated with the propulsion system and mounted on the pylon. Hence, it greatly facilitates assembly and disassembly of the system by allowing use of the dismantling interface of the pylon and the propulsion system. Moreover, the presence of a one-piece boxed section structure uninterrupted by the pylon provides a better overall distribution and a better balance of the forces on the entire periphery of the box section.

According to a first embodiment of the invention, the means of attachment of the engine are intended to be connected to a casing of a fan. Preferably, the means of attachment of the engine are intended to be fixed on a downstream part of the fan casing usually called intermediate casing and which is a structural casing.

According to a second embodiment of the invention, the means of attachment of the engine are intended to be connected to the turbojet engine at a high-pressure stage of the latter. The box section structure can then overlap all or part of an area downstream of the fan casing. Preferably, fixing is carried out through link arms, which will be advantageously placed in alignment with the side engine arms, should they be present, in such a way as to minimise disruptions of the airflow in the secondary duct of the nacelle.

Preferably, the means of attachment of the engine are arranged on the box section in such a way as to be located substantially in a horizontal plane close to a central axis of the turbojet engine.

Still preferably, the means of attachment of the engine are of the rolling type.

Still preferably, the attachment structure comprises two side means of attachment of the engine.

Advantageously, the means of attachment of the engine are arranged at a local outgrowth of the box section directed downstream of the casing.

Preferably, the box section comprises additional means of attachment having the shape of at least one rod located in a plane substantially perpendicular to a longitudinal axis of the turbojet engine, the said rod being fixed by a first end in the box section and is intended to be fixed by a second end in the casing.

Still preferably, the rod is located at the top of the box section substantially close to the means of attachment to the pylon.

According to a first embodiment of the invention, the means of attachment to the pylon are located on a side area downstream of the box section.

According to a second embodiment of the invention, the means of attachment to the pylon are located on an upper surface of the box section.

Preferably, the box section comprises additional means of attachment having the shape of at least one rod located substantially close to the means of attachment to the pylon, the said rod being fixed by a first end in the box section and is intended to be fixed by a second end to the said pylon.

Still preferably, the means of attachment to the pylon comprise at least one centering snout.

This invention also relates to a turbojet engine attachment system comprising, on the one hand, a pylon connected to a fixed structure of an airplane, and on the other hand, an attachment structure according to the invention.

Preferably, the pylon extends upstream of the attachment structure.

This invention also relates to a propulsion system comprising a turbojet engine characterised in that the turbojet engine is connected to an attachment system according to the invention.

Preferably, the propulsion system comprises a rear link through at least one suspension system having a first end connected to the pylon and a second end connected to a part downstream of the turbojet engine.

### BRIEF DESCRIPTION OF THE DRAWINGS

The actuation of the invention will be better understood from the detailed description outlined below with respect to the accompanying drawing wherein:

FIG. 1 is a schematic side view of an attachment structure according to the invention fixed to a turbojet engine.

FIG. 2 is a schematic front view of the attachment structure and of the turbojet engine of FIG. 1

FIG. 3 is a schematic view of a particular embodiment of an attachment structure according to the invention.

FIG. 4 is a schematic side view of an attachment structure according to the invention comprising additional support rods.

FIG. 5 is a front view of the attachment structure of FIG. 4.

FIG. 6 is a schematic side view of an attachment structure according to the invention connected to a pylon according to a first embodiment.

FIG. 7 is a top view of the attachment structure of FIG. 6 comprising an improved connection with the pylon.

FIG. 8 is a schematic side view of an attachment structure according to the invention connected to a pylon according to a second embodiment.

FIG. 9 is a schematic side view seen from the side of the structure of FIG. 8 comprising an additional link rod to the pylon.

Figures from 10 to 12 are other views of the arrangement of additional rods.

FIG. 13 is a schematic view of an attachment system comprising a rear suspension link to the turbojet engine.

FIGS. 14 and 15 are views, respectively front and side, of an attachment structure according to the invention linked to the turbojet engine at a high-pressure stage thereto.

### DETAILED DESCRIPTION

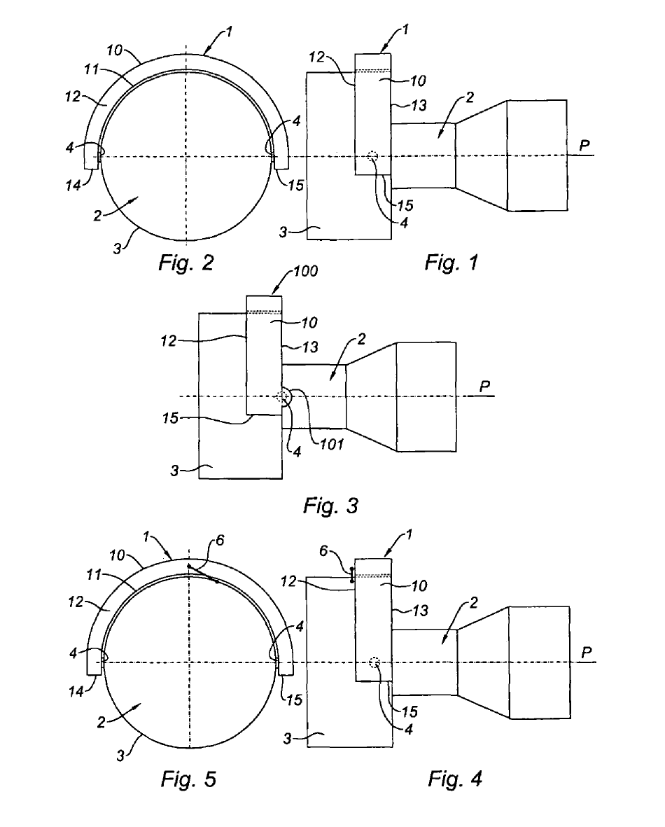

An attachment structure 1 according to the invention, such as shown in FIGS. 1 and 2, is intended to bear a turbojet engine 2.

The attachment structure has a one-piece boxed section structure surrounding a casing 3 of a turbojet engine fan 2 on a substantially upper half of the periphery thereto.

The one-piece boxed section structure 1 is shaped from an outer panel 10, an inner panel 11, a front side panel 12, and a rear side panel 13, and is enclosed by two side end panels 14, 15.

Hence, the one-piece boxed section structure 1 has a structure with a one-piece boxed section extending on each side of a longitudinal axis of the turbojet engine 2 about a fan casing 3 of the latter.

Moreover, each branch of the one-piece structure has an attachment of the engine 4, whereby the attachment structure is fixed to the fan casing 3 of the turbojet engine.

The attachment on the casing 3 is carried out in a substantially horizontal plane P close to a central axis of the turbojet engine.

These attachments of the engine 4 then react to the forces applied on the turbojet engine 2 and allow their ascent towards the pylon 5 through the boxed section structure 1.

Their localisation in a substantially horizontal plane P close to the central axis of the turbojet engine 2 allows reducing the interference forces from the engine towards the fixed structure of the airplane.

The attachments of the engine 4 may be, alternatively, of the rolling type. The axial position of the ball joint with respect to the box section will depend on the general architecture of the turbojet engine 2 and its centre of gravity.

As shown in FIG. 3, a one-piece box section structure 100 may have a local outgrowth 101 directed downstream in such a way as to allow a positioning of the attachments of the engine 4 as far downstream as possible on the fan casing 3.

In its configuration, such as shown in FIGS. 1 to 3 an attachment structure 1, 100 according to the invention mainly reacts the axial forces in the direction of the engine axis.

To react the side forces could be carried out by means of one or several additional rods 6 such as shown in FIGS. 4 and 5.

These additional rods 6 have a first end fixed in the boxed section structure 1 and a second end fixed in the fan casing 3.

Preferably, the additional rods 6 are arranged in a top area of the boxed section structure 1 close to an interface link with the pylon 5.

Obviously, the additional rods 6 may be located downstream or upstream of the boxed section structure 1 according to the geometrical layout of the system.

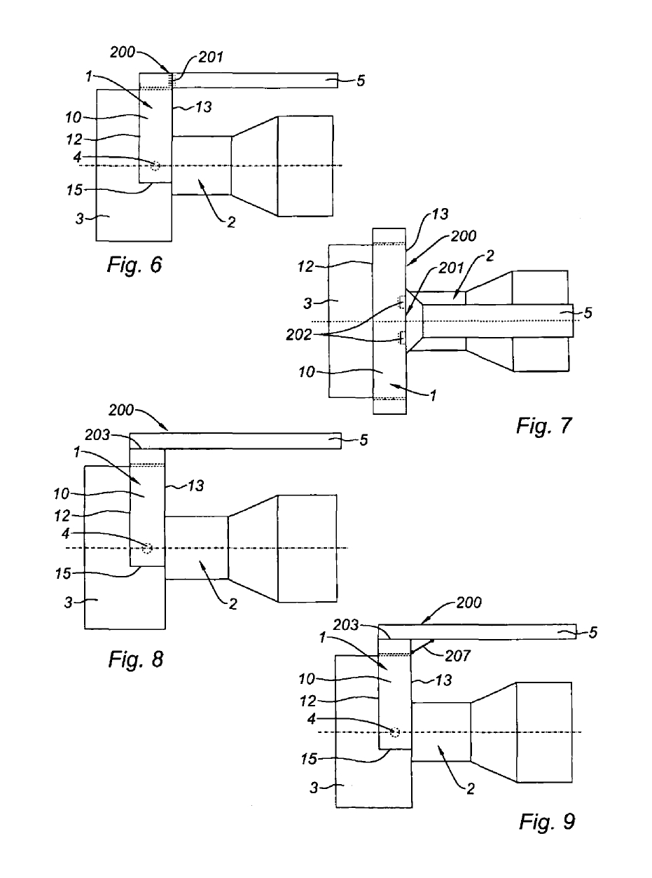

Different configurations of attachment to a pylon 5 are shown in FIGS. 6 to 13 thus forming an attachment system 200.

In FIGS. 6 and 7, pylon 5 is connected to the attachment structure 1 through an assembly interface 201 located on a side surface downstream 13 of the attachment structure 1.

The attachment may classically be carried out by fittings, preferably by removable mountings.

As shown in FIG. 7, the mounting interface 201 with the pylon 5 is expanded in order to provide a better seating and a considerable attachment surface. Crossing point forces in the desired directions may be prepared on this interface. The interface may also comprise one or several centering snouts 202.

Alternatively, as shown in FIGS. 8 and 9, a link interface 203 with the pylon 5 may be located in the upper panel 10 of the boxed section structure 1. Such an arrangement provides a larger junction surface and a better way to react the forces.

All options mentioned for the link interface described above are of course possible.

To add stiffness to the mounting, should it be necessary, and as this is shown in FIGS. 9 to 11, it is possible to add to the attachment system one or several additional rods 207 having a first end fixed in the one-piece boxed section structure 1 and a second end fixed in the pylon 5.

The additional rods may be localised under the pylon 5 (FIG. 9) but still be lateral to the pylon 5 (FIG. 10, FIG. 11).

As shown in FIG. 12, alternatively, the pylon 5 may extend upstream of the one-piece boxed section structure 1 in order to provide an additional link area between the two elements.

The various aforementioned attachment options are of course also applicable. In particular, it could comprise the provision of additional reinforcement rods 207 towards both upstream and downstream.

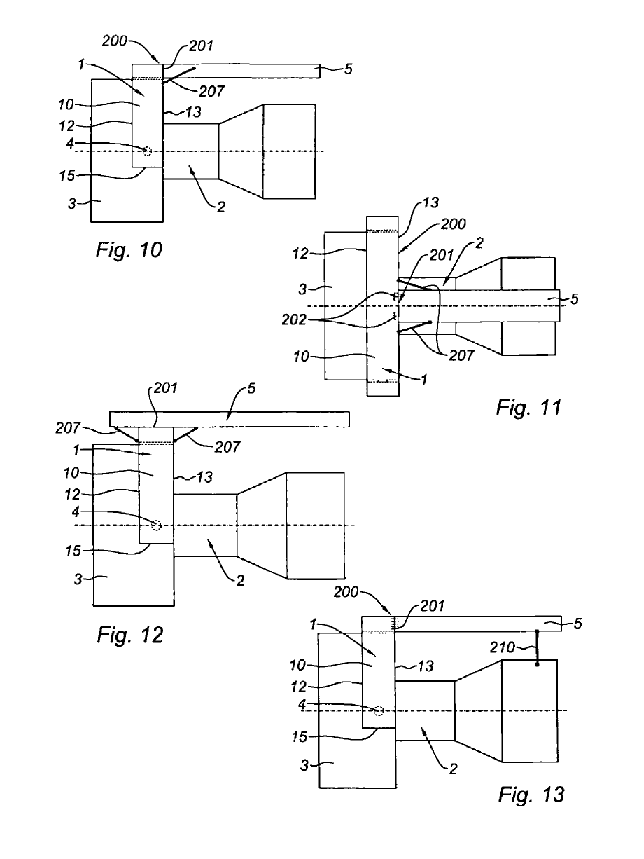

FIG. 13 shows an attachment system according to the invention equipped with a rear balance suspension 210 comprising a first end fixed to the pylon 5 and a second end fixed in a downstream part of the turbojet engine 2.

Such a suspension is known particularly from French application 06/08892 in the name and on behalf of the plaintiff.

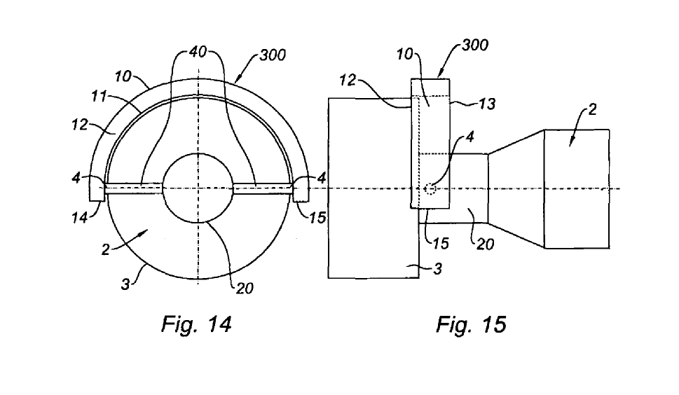

FIGS. 14 and 15 show another embodiment of an attachment structure 300 according to the invention wherein the side attachment points 4 are connected to the turbojet engine 2 at a high-pressure body 20 thereof.

The boxed section structure 300 then partially overlaps the fan casing 3. The means of attachment 4 are connected to the high-pressure body through connecting arms 40, which are preferably placed in the alignment of the side engine arms, should they exist, in order not to disrupt the airflow into the secondary duct of the nacelle. The parts of the link arms 40 passing through the secondary duct will be preferably sectioned aerodynamically. The engine side arms may integrate this outgrowth in order to strengthen this interface.

Although the invention has been described with specific examples of embodiments, it is well evident that it is not limiting and that it comprises all the equivalent technical means described, as well as their combinations should these be within the framework of the invention.

1. Attachment structure of a turbojet engine to a fixed structure of an airplane via an attachment pylon comprising a one-piece box section configured to extend at least partially on each side of a fan casing of the turbojet engine about a substantially longitudinal axis thereof and comprising. on the one hand, means of attachment to the pylon and, on the other hand, means of attachment of the engine which are positioned on the box section on each side of a substantially longitudinal axis of the turbojet engine and are configured to be connected to part of the turbojet engine in such a way as to react the forces applied thereto.

2. Attachment structure according to claim 1, wherein the means of attachment of the engine are configured to be connected to a fan casing.

3. Attachment structure according to claim 2, wherein the means of attachment of the engine are configured to be fixed on a downstream part of the fan casing.

4. Attachment structure according to claim 1 wherein the means of attachment of the engine are configured to be connected to the turbojet engine at a high-pressure stage thereof.

5. Attachment structure according to claim 1, wherein the means of attachment of the engine which are positioned on the casing in such a way as to be located substantially in a horizontal plane close to a central axis of the turbojet engine.

6. Attachment structure according to claim 1, wherein the means of attachment of the engine are of the rolling type.

7. Attachment structure according to claim 1, further comprising two side means of attachment of the engine.

8. Attachment structure according to claim 1 wherein the means of attachment of the engine are positioned at a local outgrowth of the box section, which is directed downstream of the casing.

9. Attachment structure according to claim 1, wherein the box section comprises additional means of attachment having the form of at least one rod arranged in a substantially perpendicular plane to the longitudinal axis of the turbojet engine, the said rod being fixed by a first end in the box section and is configured to be fixed by a second end in the casing.

10. Attachment structure according to claim 9 wherein the rod is arranged on the upper part of the box section substantially close to the means of attachment to the pylon.

11. Attachment structure according to claim 1 wherein the means of attachment to the pylon are arranged on a side surface downstream (13) of the box section.

12. Attachment structure according to claim 1 wherein the means of attachment to the pylon are arranged on an upper surface of the box section.

13. Attachment structure according to claim 11 wherein the box section comprises additional means of attachment having the shape of at least one rod arranged substantially close to the means of attachment to the pylon, the said rod being fixed by a first end in the box section and is configured to be fixed by a second end in the said pylon.

14. Attachment structure according to claim 11 wherein the means of attachment to the pylon comprise at least one centering snout.

15. Attachment system for a turbojet engine comprising a pylon connected to a fixed structure of an airplane and an attachment structure according to claim 1.

16. Attachment system according to claim 15 wherein the pylon extends upstream of the attachment structure.

17. Propulsive system comprising a turbojet engine wherein the turbojet engine is connected to an attachment system according to claim 15.

18. Propulsive system according to claim 17 further comprising a rear link by means of at least a suspension system having a first end connected to the pylon and a second end connected to a part downstream of the turbojet engine.
